(19) United States
(12) Patent Application Publication
(10) Pub. No.: US 2022/0297354 A1
(43) Pub. Date: Sep. 22, 2022

(54) AN ADJUSTABLE SURFACE AND METHODS OF USE

(71) Applicant: Arizona Board of Regents on Behalf of the University of Arizona, Tucson, AZ (US)

(72) Inventors: Christian Davila-Peralta, Tucson, AZ (US); Justin James Hyatt, Tucson, AZ (US); Eric Patterson, Tucson, AZ (US)

(21) Appl. No.: 17/642,466

(22) PCT Filed: Sep. 11, 2020
(86) PCT No.: PCT/US2020/050568

§ 371 Date: Mar. 11, 2022

Related U.S. Application Data
(60) Provisional application No. 62/899,093, filed on Sep. 11, 2019.

(51) Int. Cl. B29C 33/30; B29C 51/30; B29C 51/20; B29C 70/54

(52) U.S. Cl. CPC B29C 33/308; B29C 33/302; B29C 51/30; B29C 51/20; B29C 70/54

(57) ABSTRACT

A system is provided that includes an adjustable surface that can be quickly adjusted through use of a plurality of actuators. The surface can be used as a dynamic decoration or a haptic visualization tool for the blind. The system uses special couplings between the actuators and the adjustable surface that allow the actuators to control the shape of the surface, while still allowing the surface to be deformed by outside pressure without forcing or damaging the actuators. These couplings formed by a selection of springs, flexures, cables, and ball joints allow the surface to be quickly adjusted to a new shape. The adjustable surface can be used to shape plastic, metal, or glass sheets or as composite layup forms. A frame of the system engages actuators in a way that allows the actuators to move in axial directions of the actuators and adjust the shape of the surface.

### CROSS-REFERENCE TO RELATED APPLICATIONS

This Patent Cooperation Treaty (PCT) international application claims priority to, and the benefit of the filing date of, U.S. provisional application No. 62/899,093, filed on Sep. 11, 2019, entitled “AN ADJUSTABLE SURFACE AND METHODS OF USE,” which is incorporated herein by reference in its entirety.

### TECHNICAL FIELD

The present disclosure is directed to an adjustable surface, and more particularly, to an adjustable surface that is suitable for use in a variety of applications.

### BACKGROUND

Several technologies require the use of molding surfaces to shape different materials to achieve an arbitrary geometry. These technologies, such as stamping, thermoforming, hydroforming, fiberglass forming, carbon fiber forming and others, typically use a mold or dies fabricated from a solid block of hard material. The form is machined using different technologies until its faces have the desired geometry. These machining methods that are used to produce the mold are expensive and time consuming. In addition, the shape of a machined mold must be compensated for springback in the piece to be formed. Springback is a complicated phenomenon that cannot be straightforwardly modeled. Often, determining the springback compensation is an iterative process where the dies are re-machined multiple times. Also, in high production, the dies wear, causing continual quality degradation.

Surfaces with different geometries are required for different industries such as, for example, reflective panels for radio telescopes, antennas for telecommunications, reflective panels for solar energy concentration, panels for wings or fuselages in the aerospace industry, automotive panels, architectural facades or walls, and others. These panels are made by a variety of processes. Some of the preferred processes include, for example, machining, stamping, thermoforming and hydroforming.

A need exists for improved, cost-effective processes for forming such surfaces.

### SUMMARY

The present disclosure discloses systems and methods for shaping a work piece panel into a preselected shape. In accordance with a representative embodiment, the system comprises an adjustable surface comprising a plurality of segments, a substantially rigid frame and a plurality of linear actuators. Each linear actuator has at least first and second ends. The first ends are coupled to a segment of the adjustable surface and the second ends are coupled to the frame. Each linear actuator is adjustable along an axial direction of the respective linear actuator to control a distance between a location on the rigid frame to which the second end of the respective linear actuator is coupled and the segment of the adjustable surface to which the first end of the respective linear actuator is coupled such that adjustment of one or more of the linear actuators adjusts a shape of the adjustable surface.

In accordance with an embodiment of the system, the plurality of segments comprise an array of tiles.

In accordance with an embodiment of the system, adjacent tiles of the array of tiles are interconnected by spring elements allowing select degrees of freedom of motion and directions of flexibility while limiting the flexibility in other degrees of freedom of motion relative to adjacent tiles.

In accordance with an embodiment of the system, the actuators are arranged in a three-dimensional pattern.

In accordance with an embodiment of the system, each actuator comprises a threaded screw that can be used for fine tuning the actuators by turning the threaded screws to adjust at least one of a height and an angle of inclination of the respective tile.

In accordance with an embodiment of the system, each threaded screw can be adjusted from the first end.

In accordance with an embodiment of the system, the coupling between each actuator and the adjustable surface comprises a ball joint or universal joint to constrain selected degrees of freedom of motion of the tile.

In accordance with an embodiment of the system, the tiles are discrete and disconnected from one another. The tile is mechanically coupled to the first end of at least one of the actuators for positioning and orienting of the respective tile.

In accordance with an embodiment of the system, the angle of a tile is controlled at least in part by the spring elements interconnecting the respective tile to one or more adjacent tiles.

In accordance with an embodiment of the system, at least one of the tiles is not coupled to any of the actuators.

In accordance with an embodiment of the system, at least one spring maintains pressure between at least one of (1) the first end of the respective actuator and the adjustable surface and (2) between the second end of the actuator and the frame.

In accordance with an embodiment of the system, the spring elements comprise flexure elements, and the tiles and the flexure elements are cut from at least one sheet of material.

In accordance with an embodiment of the system, the adjustable surface is cut from a curved sheet of material and the flexure elements are formed in the curved sheet of material.

In accordance with an embodiment of the system, at least one of the size and the shape of at least two of the tiles differ and the flexibility and configuration of at least two of the spring elements differ to provide more or less flexibility in the adjustable surface in select directions in select locations of the surface.

In accordance with an embodiment of the system, the first and second ends of the actuators are coupled to the adjustable surface and the frame, respectively, by flexible cable or chain so that the actuators can pull the tile closer to the frame without laterally constraining the location of the tile.

In accordance with an embodiment of the system, the actuators wind or tension the cables or chains to adjust the adjustable surface.

In accordance with an embodiment of the system, the system further comprises a computerized tool that automatically adjusts each actuator by rotating the screw through a certain angle. In accordance with an embodiment of the system, the tool measures at least one of the position and the angle of the tile and uses the measurement to determine an amount by which the actuator is to be adjusted.

In accordance with an embodiment of the system, the actuators are motorized and digitally output at least one of a position and an angle of the respective tiles.

In accordance with an embodiment of the system, the system further comprises a computer that performs an algorithm that dynamically varies the axial positions of the actuators to cause the adjustable surface to form a predetermined three-dimensional shape.

In accordance with an embodiment of the system, the adjustable surface acts as a dynamic surface for a decorative or architectural function.

In accordance with an embodiment of the system, the adjustable surface acts as a tactile visualization tool for blind people to experience contour devices and objects.

In accordance with an embodiment of the system, the adjustable surface comprises a mold for forming curved sheets of metal, plastic, glass, or other material using one or more thermal heating techniques.

In accordance with an embodiment of the system, the adjustable surface comprises a mold for laying up composite materials.

In accordance with an embodiment of the system, the shape of the adjustable surface is achieved by placing the adjustable surface in contact with a negative surface having a preselected shape that causes the adjustable shape to conform to the other surface.

In accordance with an embodiment of the system, the couplings between the first ends of the actuators and the adjustable surface allow the shape of the adjustable surface to be changed to a new shape without altering the linear positions of the actuators by allowing a loss of tension or pressure in the couplings between the first ends of the actuators and the adjustable surface.

In accordance with an embodiment of the system, the actuators adjust their linear positions to conform to the new shape of the adjustable surface.

In accordance with an embodiment of the system, the system further comprises a sensor that detects the tension or pressure in the coupling between the first end of each actuator and the adjustable surface to determine when the actuators have reached linear positions that conform to the new shape of the adjustable surface.

In accordance with an embodiment of the system, the linear positions of the actuators are adjustable to fine tune the new shape of the adjustable surface.

In accordance with an embodiment of the system, the actuators are interconnected by use of a coupling mechanism such that the motion of a plurality of the actuators is driven by a single motor.

In accordance with an embodiment of the system, the system comprises a substantially rigid frame, a plurality of linear actuators, each being adjustable along an axial direction of the actuator, an adjustable surface mechanically coupled to the plurality of actuators, a locking mechanism, and quick-release mechanism. Adjustment of the actuators adjusts a shape of the adjustable surface, and vice versa. The locking mechanism is configured to lock the actuators in preselected axial positions. Locking in the actuators at the preselected axial positions causes the adjustable surface to have a preselected shape. Actuation of the quick-release mechanism causes the locking mechanism to unlock, which frees the actuators to allow the actuators to move freely in the axial directions of the actuators.

In accordance with an embodiment of the system, each actuator can be fine tuned after the actuators have been locked in the preselected axial positions.

In accordance with an embodiment of the system, each actuator can be coarsely tuned by actuating the quick-release mechanism to cause the locking mechanism to unlock and causing an external surface having a preselected shape to be placed in contact with the adjustable surface. Causing the external surface to be placed in contact with the adjustable surface causes the adjustable surface to exert forces on the actuators that cause the actuators to be coarsely tuned to the preselected axial positions of the actuators. Once the actuators have been coarsely tuned, the locking mechanism can be locked to lock the actuators in the coarsely tuned preselected axial positions.

In accordance with an embodiment, the system comprises a substantially rigid frame, a plurality of linear actuators, each being adjustable along an axial direction of the actuator, an adjustable surface mechanically coupled to the plurality of actuators, wherein adjustment of the actuators adjusts positions of some or all of the surface to adjust the shape of the adjustable surface, and vice versa, and a computer that performs an algorithm for dynamically varying the axial positions of the actuators to cause the adjustable surface to form a predetermined three-dimensional shape to allow the adjustable surface to act as a tactile visualization tool for blind people to experience contour devices and objects.

In accordance with an embodiment of the system, the computer performs an algorithm for dynamically varying the axial positions of the actuators to cause the adjustable surface to form a predetermined three-dimensional shape to allow the adjustable surface to act as a dynamical surface for decoration or architectural function.

In accordance with an embodiment of the method, the method comprises:

actuating a quick-release mechanism to cause a locking mechanism to unlock, wherein unlocking of the locking mechanism frees a plurality of linear actuators to allow the linear actuators to move freely in axial directions of the linear actuators;

placing an adjustable surface in contact with the surface having the preselected shape, the adjustable surface comprising a flexible surface that is mechanically coupled to the plurality of linear actuators, each actuator being adjustable along an axial direction of the actuator and being coupled to a substantially rigid frame, wherein placing the adjustable surface in contact with the surface having the preselected shape causes some or all of the actuators to adjust the linear positions of the actuators; and

with the locking mechanism, locking the actuators in the linear positions, wherein locking the actuators in the linear positions causes the adjustable surface to substantially conform to the preselected shape.

In accordance with an embodiment of the method, the method further comprises: after locking the actuators in the linear positions, performing a fine tuning process that measures the shape of the adjustable surface and fine tunes the linear positions of the actuators to ensure that the adjustable surface precisely conforms to the preselected shape.

In accordance with an embodiment of the method, the method further comprises: after using fine tuning the adjustable surface, using the adjustable surface as a mold to mold a part having the preselected shape.

In accordance with an embodiment of the method, the method further comprises: after using the adjustable surface as a mold to mold a part having the preselected shape, performing a fine tuning process that measures the shape of the molded part and fine tunes the linear positions of the actuators to ensure that the adjustable surface produces a part accurately and precisely having the preselected shape.

These and other features and advantages will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a front view of the system in accordance with a representative embodiment.

FIG. 2 is a front view of the system shown in FIG. 1 that demonstrates a rapid method of coarse shaping of the adjustable surface of the system shown in FIG. 1 in accordance with a representative embodiment.

FIG. 3 is a front view of the system in accordance with a representative embodiment where the shape of the adjustable surface is changed by a tool that simultaneously measures the shape of the surface and adjusts screw actuators from the side where they couple to the adjustable surface.

FIG. 4 is a front view of the system in accordance with a representative embodiment where the shape of the adjustable surface is changed by a tool that adjusts screw actuators from the side where they couple to the frame based on measurement of the shape of the adjustable surface by another tool.

FIG. 5 is a top view of a representative embodiment of the adjustable surface.

FIG. 6 is a side view of a representative embodiment showing a dynamic decorative surface where linear actuators are driven by a camshaft.

FIG. 7 is a perspective view of the system in accordance with a representative embodiment.

FIG. 8 is a top view of the rigid frame shown in FIG. 7 without the adjustable surface.

FIG. 9 is a top view of the system shown in FIG. 7.

FIGS. 10-16 depict a 2-D cross section of a process of coarsely tuning an adjustable surface of a system in accordance with a representative embodiment, finely tuning the adjustable surface and using the finely-tuned adjustable surface to shape surfaces.

### DETAILED DESCRIPTION

The present disclosure discloses improved, cost-effective systems and processes for forming a variety of the aforementioned types of surfaces. In accordance with a representative embodiment, a system is provided that includes an adjustable surface that can be quickly adjusted through use of a plurality of actuators. The adjustable surface can be used as a dynamic decoration or architectural feature. It can also be used as a mold for composite layup. The adjustable surface can also be used to shape plastic, metal, or glass sheets or other materials with high accuracy.

In accordance with an embodiment, the system comprises an adjustable surface, a substantially rigid frame, and a plurality of linear actuators. Each linear actuator has at least first and second ends. The first ends of each of the actuators are coupled to segments of the adjustable surface and the second ends of the actuators are coupled to the frame. Each linear actuator is adjustable along an axial direction of the respective linear actuator to control the distance between a location on the rigid frame to which the second end of the respective linear actuator is coupled and the segment of the adjustable surface to which the first end of the respective linear actuator is coupled such that adjustment of one or more of the linear actuators adjusts the shape of the adjustable surface.

In the following detailed description, for purposes of explanation and not limitation, exemplary, or representative, embodiments disclosing specific details are set forth in order to provide a thorough understanding of inventive principles and concepts. However, it will be apparent to one of ordinary skill in the art having the benefit of the present disclosure that other embodiments according to the present teachings that are not explicitly described or shown herein are within the scope of the appended claims. Moreover, descriptions of well-known apparatuses and methods may be omitted so as not to obscure the description of the exemplary embodiments. Such methods and apparatuses are clearly within the scope of the present teachings, as will be understood by those of skill in the art. It should also be understood that the word “example,” as used herein, is intended to be non-exclusionary and non-limiting in nature.

The terminology used herein is for purposes of describing particular embodiments only, and is not intended to be limiting. The defined terms are in addition to the technical, scientific, or ordinary meanings of the defined terms as commonly understood and accepted in the relevant context.

The terms “a,” “an” and “the” include both singular and plural referents, unless the context clearly dictates otherwise. Thus, for example, “a device” includes one device and plural devices. The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art. Relative terms, such as “over,” “above,” “below,” “top,” “bottom,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

Relative terms may be used to describe the various elements' relationships to one another, as illustrated in the accompanying drawings. These relative terms are intended to encompass different orientations of the device and/or elements in addition to the orientation depicted in the drawings.

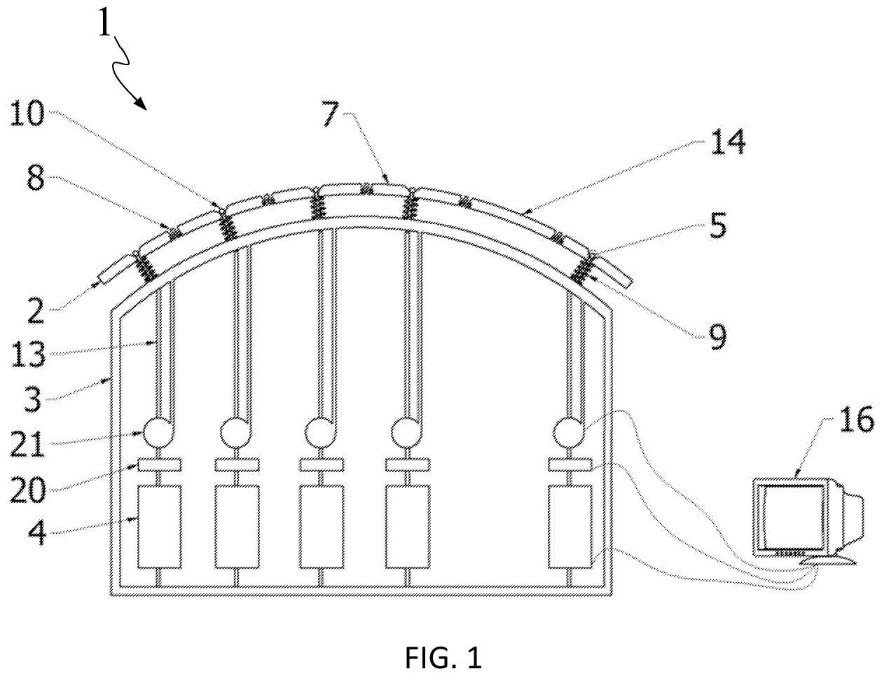

FIG. 1 is a front view of the system 1 in accordance with a representative embodiment. A rigid frame 3 of the system 1 engages a plurality of actuators 4 in a way that allows the actuators 4 to move relative to their axes. An adjustable surface 2 of the system 1 is mechanically coupled to the actuators 4 via joints 5, which preferably are ball joints 10 or universal joints. The adjustable surface 2 can be flexed by the actuators 4 into a desired shape to serve as a curved surface or a form for the manufacture of a conformal object. This adjustable surface 2 may be composed of segments or tiles 7. This adjustable surface 2 may be metal that is made flexible by cutting a pattern of flexures 8 in it to allow flexibility in select degrees of freedom of motion while maintaining surface continuity and substantial structural stability in other degrees of freedom of motion. The flexures 8 also allow for relative shifting or separating of the tiles 7 due to distortion caused by changing the shape of the adjustable surface 2. The surface 2 may also contain floating tiles 14 that are not connected to actuators 4. The position and orientation of these tiles 14 are partially constrained by the flexures 8 that connect these floating tiles 14 to the neighboring actuated tiles 7. The surface 2 may also be a continuous sheet of a flexible material (e.g., rubber).

The ball joints or other universal joints 10 may allow free orientation angle of a tile 7 while constraining the position of the tile 7 in one or more degrees of freedom. For example, the joint 10 may comprise a flat plate in contact with a spherical tip of the actuator 4. A spring 9 or other attachment may hold the plate in contact with the spherical tips.

The actuators 4 may be coupled to the adjustable surface 2 and/or the frame 9 by cables 13 or chains so that the coupling only constrains the distance between the surface 2 and the frame 3 and does not exert any lateral force on the surface element 7. A load cell 20 or other sensor may be incorporated into the coupling between the actuator 4 and the adjustable surface 2 and/or the frame 3 to measure the tension or pressure in the coupling. An encoder 21 or other sensor may be used to measure the distance between the frame 3 and the adjustable surface 2, or to measure the displacement of the adjustable surface 2 relative to the frame 3. A computer 16 may read the information from the load cell 20 and the distance encoder 21 and use that information to drive the actuator 4.

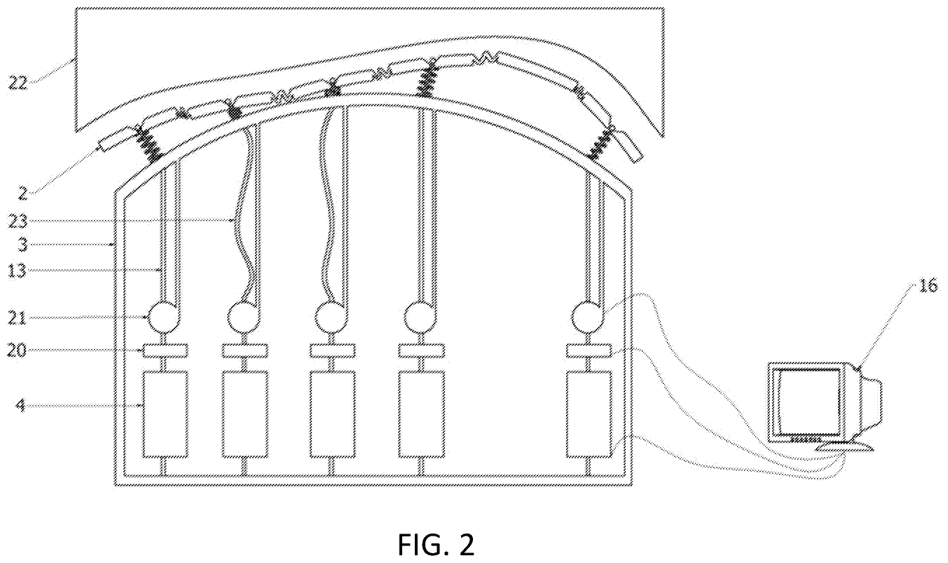

FIG. 2 demonstrates a rapid method of coarse shaping of the adjustable surface 2. The shape of the adjustable surface 2 can be set quickly by conforming it to a shaped negative 22. While the adjustable surface 2 is deforming, the cables 13 allow for compression of the springs 9 without forcing or damaging the actuators 4. Some cables 13 may become loose, as indicated by reference numeral 23. This loss of tension can be detected by the load cells 20. The actuators 4 can then adjust until tension is resumed. The actuators 4 can then further adjust the surface 2 to fine tune its shape using information provided by the encoders 21.

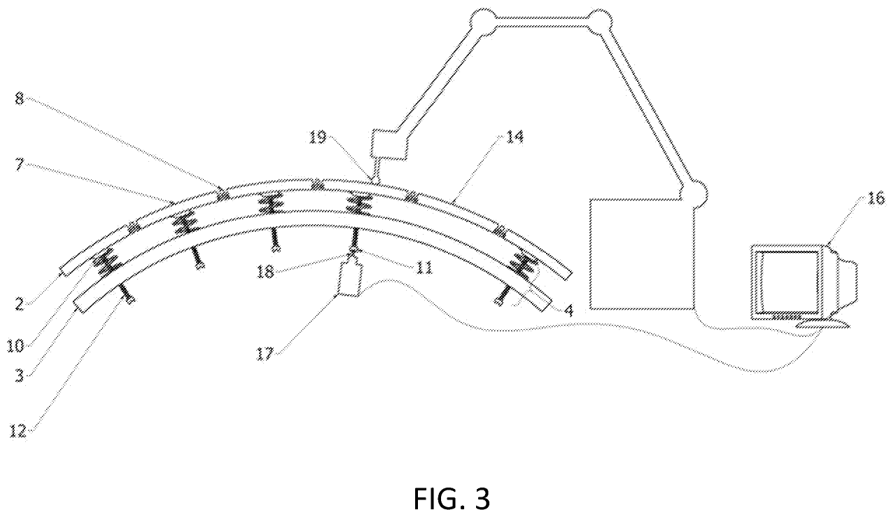

FIG. 3 shows a front view of another preferred embodiment in which the actuators 4 comprise a threaded screw 12. The frame 3 may contain threaded holes where it couples to the screws 12 providing the actuation mechanism. A ball joint 10 comprises the coupling between an actuator 4 and the adjustable surface 2. This allows segments or tiles 7 of the adjustable surface 2 to change their orientation angle while enforcing a distance between the tile 7 and the frame 3.

In the embodiment shown in FIG. 3, the linear position of an actuator 4 may be adjusted by a tool 17 where the tip 18 of the tool 17 engages with the head 11 of the screw 12. In this embodiment, the tool 17 is motorized and a computer 16 drives the motor a specific angle of rotation to adjust the actuator 4 a specific distance. A physical probe 19 or optical sensor may measure the position and/or orientation of a tile 7. This may provide iterative or real-time closed-loop feedback to the computer 16 to determine the rotation of the tool 17.

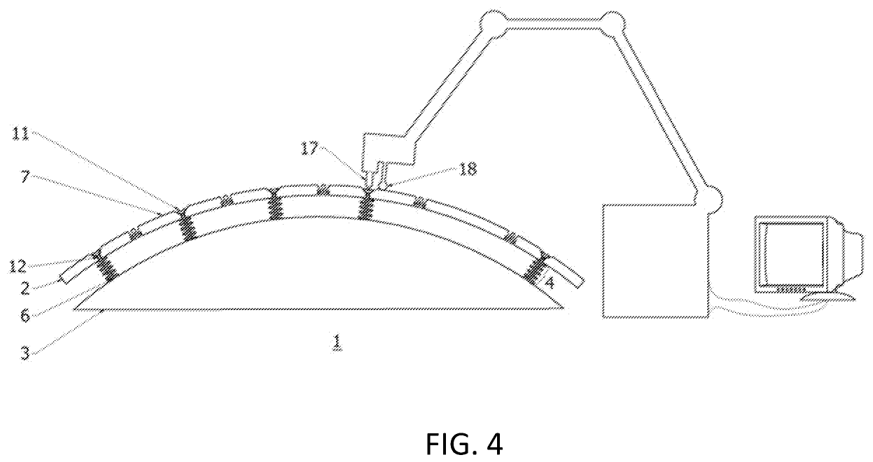

FIG. 4 shows a front view of another preferred embodiment in which the actuators 4 comprise a threaded screw 12. In this embodiment, the actuators 4 can be adjusted from the top of the system 1 (the side of the actuator 4 that couples to the adjustable surface 2). The head of the screw 11 may have a spherical seat to allow it to rotate freely in a socket in the tile 7. The frame 3 may contain threaded holes 6 where it couples to the screws 12 providing the actuation mechanism. This allows for an adjustment tool 17 to contain a measurement probe 18 to measure and adjust the position or orientation of a tile 7 in the same location with a single apparatus.

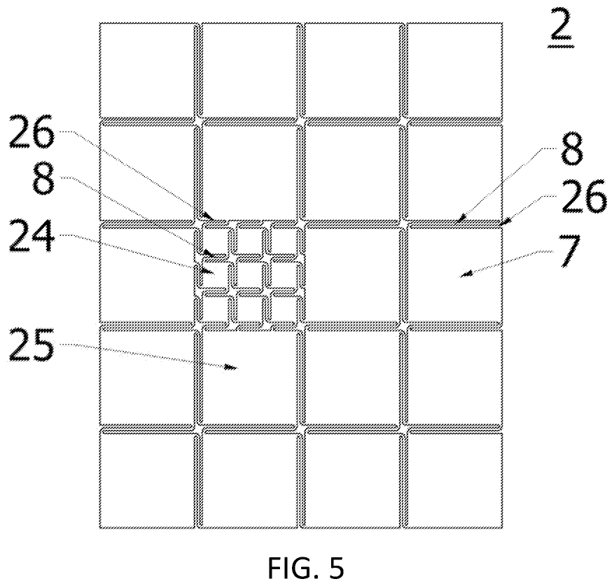

FIG. 5 shows a top view of a representative embodiment of the adjustable surface 2. In some embodiments, the tiles 7 are interconnected by springs or flexures 8. In accordance with the representative embodiment shown in FIG. 5, the flexures 8 are formed by forming slots 26 of predetermined lengths and widths at predetermined locations in the material comprising the adjustable surface 2 (e.g., stainless steel). The slots 26 give the surface 2 a preselected amount of flexibility and continuity. The types of springs 8 that are used to interconnect the tiles 7 are not limited to slots or any other type of configuration.

The tiles 7 can have any shape. Generally, they will be of shapes that can tessellate such as squares or hexagons, although this is not required. The shape and size of the tiles 7 may be different in different locations of the adjustable surface 2. This may provide greater flexibility or shape accuracy in a certain region or direction of the surface while requiring fewer actuators in other regions. For example, smaller tiles 24 may be used in an area that requires a sharper curvature, while larger tiles 25 may be used in an area that will be flatter.

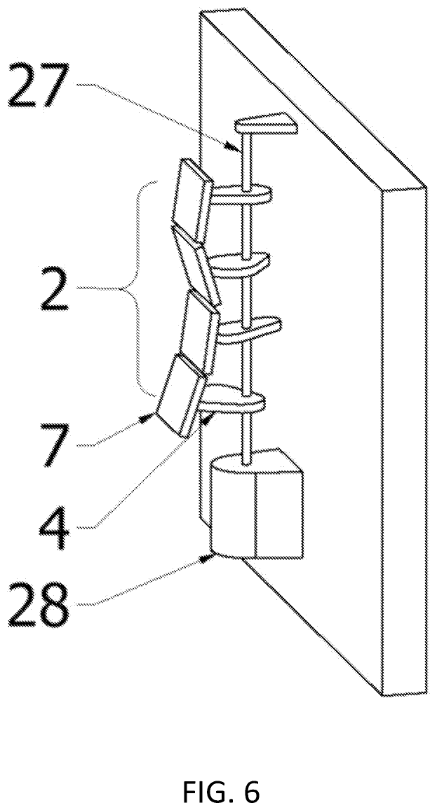

FIG. 6 shows a side view of an application of the adjustable surface 2 where it is used as a dynamic decoration or 3-D visualization. A motorized camshaft 27 comprises the actuators 4. As the shaft 27 rotates, the tiles 7 move, continuously changing the shape of the surface 2. The actuators 4 may also be individual and independent as in other embodiments, and the motion may be controlled electronically.

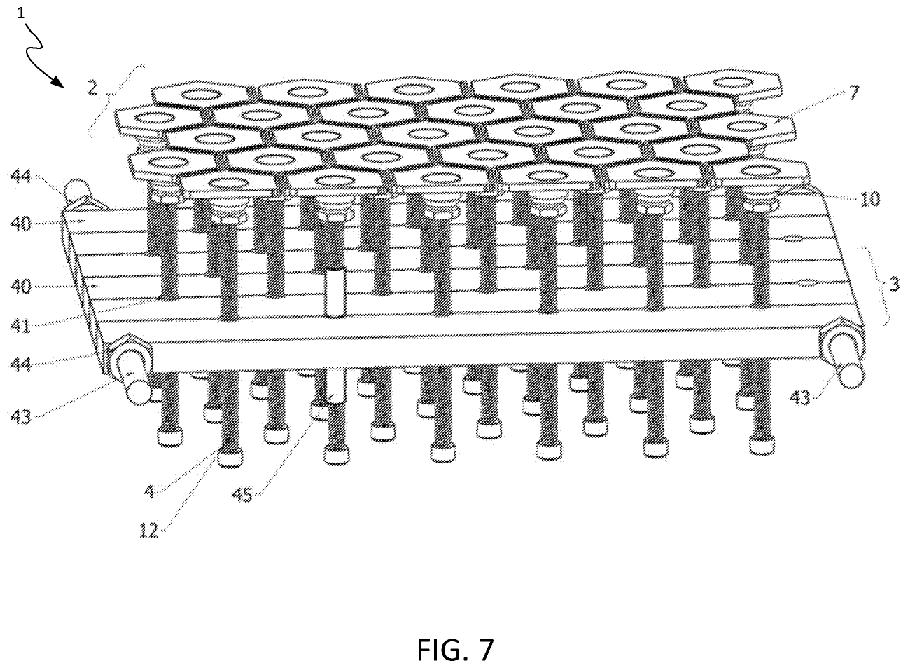

The system 1 may include a quick release and locking mechanism, as illustrated in FIGS. 7-16. The quick release mechanism and the locking mechanism allow the actuators to be quickly released so that they move freely in their axial directions within limits and to be locked in position to prevent movement in their axial directions. A variety of quick release and locking mechanisms may be used for this purpose. The inventive principles and concepts are not limited to any particular configurations for the quick release and locking mechanisms, as will be understood by those of skill in the art in view of the description provided herein.

In accordance with one representative embodiment of the method, a surface having the negative of the desired shape 22 (FIG. 2) is fabricated using an inexpensive material (e.g., wax or foam) that is easy to machine. Once the surface having the negative of the desired shape 22 (e.g., a parabola) has been formed, the quick-release mechanism of the system 1 is released, which allows all of the actuators 4 to move freely in their axial directions, i.e., slide into position. The system 1 is then placed on the negative surface 22 such that adjustable surface 2 comes into contact with, and takes the shape of, the negative surface 22. In other words, each actuator 4 moves in the axial direction until the respective tile 7 locally takes the shape of the negative surface 22. The locking mechanism 40-45 (FIG. 7) of the system 1 is then locked in place to lock the adjustable surface 2 in the shape of the negative surface 22.

Once the locking mechanism 40-45 of the system 1 has been locked to lock in the preselected shape, each of the actuators 4 can still be turned to fine tune their positions. The adjustable surface 2 may then be used in, for example, a thermoforming process to thermoform metal panels, glass panels, plastic panels, etc. It can also be used to form panels by induction thermoforming or convection thermoforming. It could also be used as a mold for composite layup. The materials that are used in the system 1 should be able to withstand high temperatures if the system 1 is to be used with a heat source. For example, the system 1 can be made of stainless steel if it is to be used in an oven. However, the system 1 can be used in cold or moderate temperature environments, such as for shaping carbon fiber surfaces. The fine tuning of the actuators 4 may be done electronically with, for example, motors and encoders. If electronics are connected to the actuators, then suitable insulation may be used to protect them from high temperatures.

It should be noted that once the adjustable surface 2 has been locked into position and fine tuned, the adjustable surface 2 can be used as the final product. For example, the slots 26 (FIG. 5) can be filled in with epoxy, the epoxy cured and polished, and the actuators 4 and frame 3 removed to make the product ready for shipping.

In accordance with another embodiment, the negative surface 22 may be a second system similar or identical to system 1. For example, a second system that is similar to system 1 can have motors and a computer for adjusting the actuators of the second system to achieve a predetermined shape that is substantially the negative of the desired shape for the adjustable surface 2 of the system 1. The second system may then be used with the system 1 to tune the actuators 4 of the system 1 in the same way that the negative foam or wax shape 22 is used to tune the actuators 4. The second, motorized system would not need to be designed to withstand high temperatures, so it can have electronics and be made of cheaper materials, such as plastic, aluminum or rubber. The quick release and locking mechanism 40-45 and actuators 4 of the system 1 may be made of materials that do withstand high temperatures. After the system 1 is locked in the correct shape, it can be removed from the negative system 22 and placed inside a high temperature environment.

FIG. 7 is a perspective view of the system 1 in accordance with a representative embodiment that includes a quick release and locking mechanism. In accordance with a representative embodiment, the rigid frame 3 includes clamping mechanisms that hold the actuators 4 in their axial positions. The frame 3 comprises multiple bars 40 that clamp together. The actuators 4 pass through circular openings 41 formed between the bars 40. Each bar 40 has multiple semi-circular indents, the inner surfaces of which clamp to the threads of the actuators 4 when the bars 40 are clamped together. The clamps 42 may be clamps that hold adjacent pairs of bars together or that clamp two or more bars 40 to form a slab. In this depiction, the clamps are shown as threaded rods 43 that pass through the bars 40. Nuts 44 on the ends of the rots 43 tighten together to clamp the bars 40 onto the actuators 4. To lock the actuators 4 in place, these bars 40 may clamp down onto the threads of the actuators 4 or onto sleeves 45, which contain the actuators 4.

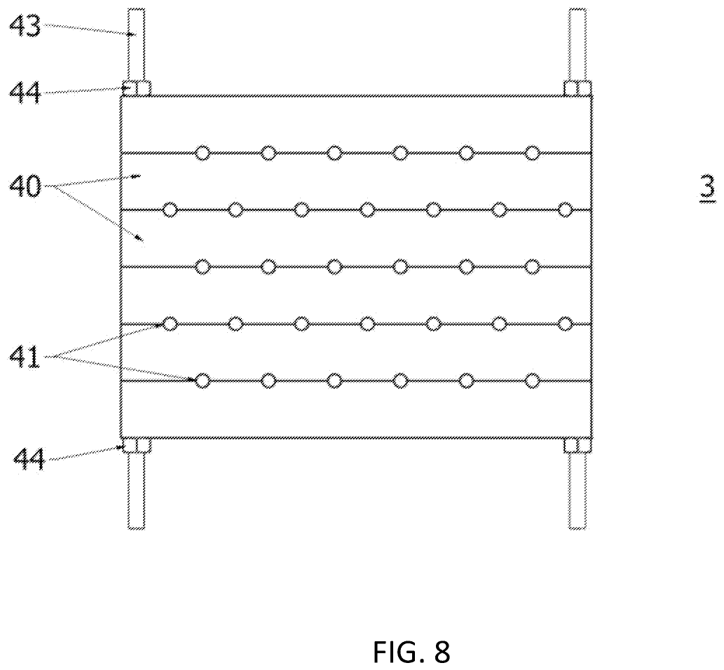

FIG. 8 is a top view of the system 1 shown in FIG. 7. This figure illustrates an embodiment of the adjustable surface 2 that uses tiles 7 that are hexagonal.

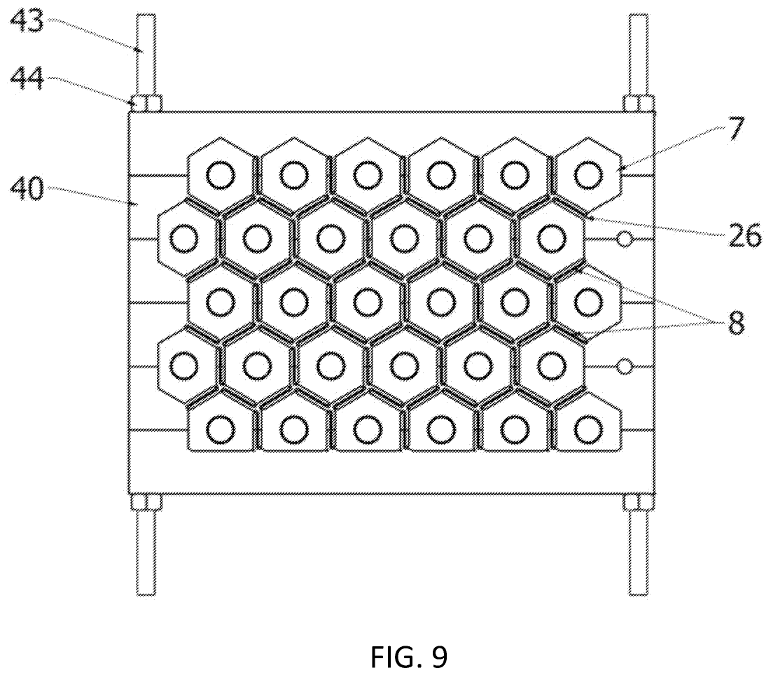

FIG. 9 is a top view of the rigid frame 3 shown in FIG. 7 without the actuators 4. It illustrates how the circular holes 41 shown in FIG. 8 are formed by clamping together bars 40 that have partial circular indents that clamp against the threads of the actuators 4 or against sleeves 45 that hold the actuators 4.

As indicated above, the actuator 4 can include a threaded screw 12. If the system 1 is designed to be used in an oven, it will typically be made out of stainless steel parts, although other materials that can withstand high temperatures may be used. However, if the bars 40 and the semi-circular openings 41 that clamp to the threaded screw 12 are both made of stainless steel, a condition known as galling can occur, which can lead to other problems. This problem can be overcome by using a nut or sleeve 45 made of another material (e.g., brass) that has a threaded opening formed therein for receiving the threaded screw 12 in threading engagement. In this case, the actuator 4 comprises the screw 12 and the sleeve 45. The quick-release mechanism can be used to clamp and release the threaded sleeve 45 to allow the nut 45 and the screw 12 to be moved as one unit into the desired position. The actuator 4 can then be locked into position by using the clamping arrangement 40-44 described above to clamp onto the threaded nut 45 once the actuator 4 is in the desired position. Once locked into place, the actuator 4 can be fine tuned by turning the threaded screw 12 by the desired amount. Representative embodiments of the fine-tuning process in accordance with an embodiment are described below in more detail.

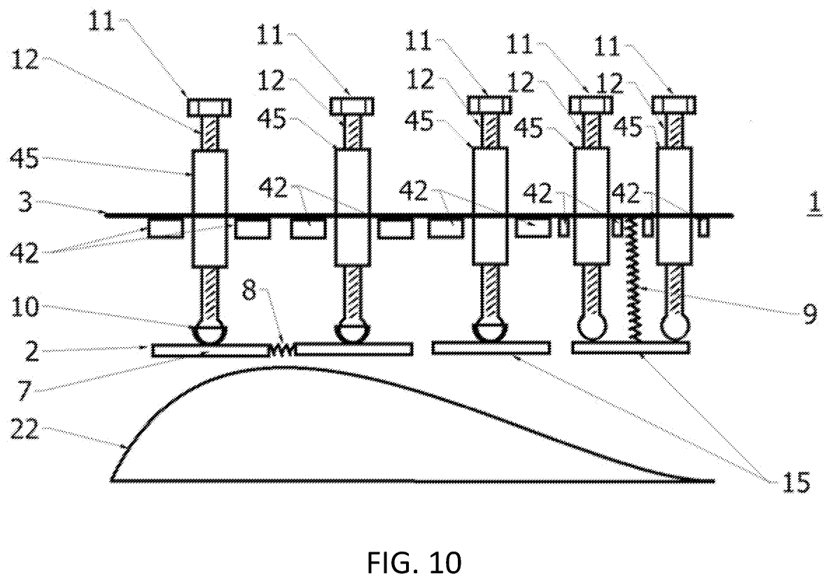

An example of the processes of coarse tuning the actuators, fine tuning the actuators and then using the system to produce a product will now be described with reference to FIGS. 10-16. In accordance with this representative embodiment, the adjustable surface 2 comprises a plurality of tiles 7, some of which are connected by springs or flexures 8 with adjacent tiles 7 and some that are independently actuated 15 and not connected to adjacent tiles 7 by springs or flexures 8.

In FIG. 10, the system 1 is in the quick-released, or unlocked, state, i.e., the clamps 42 of the locking mechanism are not clamped about the sleeves 45 of the actuators 4. Thus, the actuators 4 comprising the screws 12 and sleeves 45 can move freely in their axial directions. In FIG. 10, the adjustable surface 2 has not yet come into contact with a negative surface 22, i.e., a surface having a shape that is the shape of a product that the system 1 will later be used to form.

FIG. 10 also shows that in some embodiments, some tiles 15 are not interconnected by springs or flexures 8 and can be moved independently of one another. For example, each tile 15 can be controlled by a plurality (e.g., three) of actuators 4 to allow positioning of the tiles 15 at a preselected height with a preselected angle of inclination.

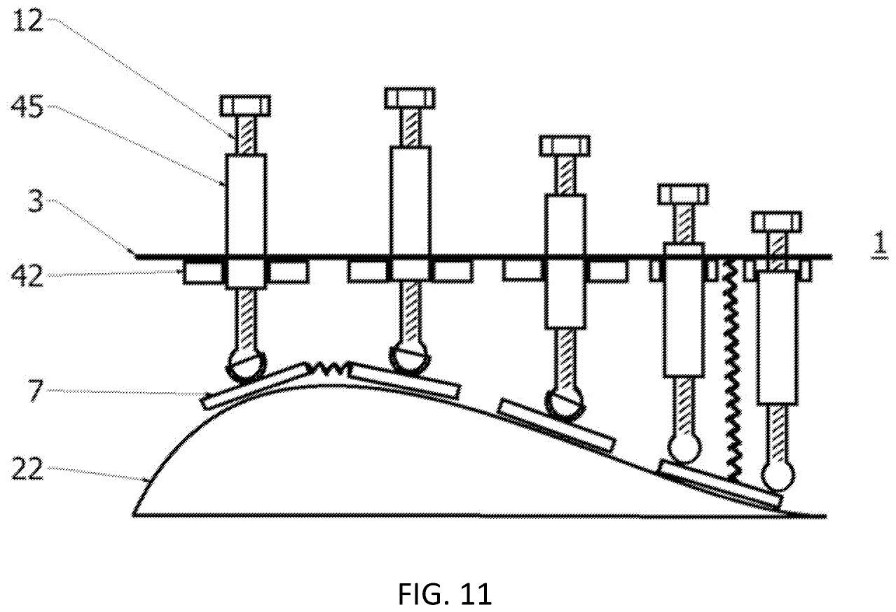

In FIG. 11, the negative surface 22 has been placed in contact with the adjustable surface 2 such that the tiles 7 have adjusted in position and orientation to conform to the negative surface 22. The actuators 4 have been locked by tightening the clamps 42 around the sleeves 45. Thus, the coarse tuning process is complete.

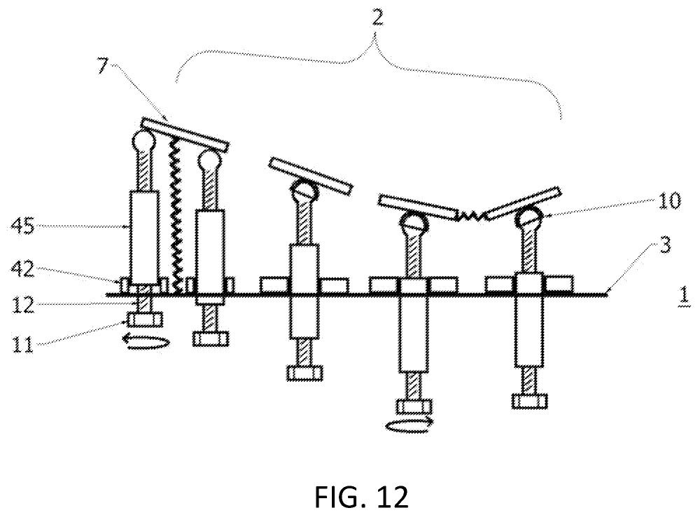

In FIG. 12, the clamps 42 are locked around the sleeves 45 to limit the motion of the actuators 4. The system 1 is removed from the negative surface 22 and turned over. The fine tuning of the shape of the adjustable surface 2 process described above is performed by turning the heads 11 of the screws 12 of the actuators 4. As shown in FIG. 3, a measuring tool and the associated algorithms can be used during the fine tuning process to ensure that the tiles 7 are precisely positioned.

At the stage of the process depicted in FIG. 12, the adjustable surface 2 can be modified to become the end product by, for example, filling the openings 26 in between the tiles 7 with epoxy, curing the epoxy and then polishing the adjustable surface 2. Alternatively, the system 1 can now be used as a mold to mold other devices, such as panels, for example.

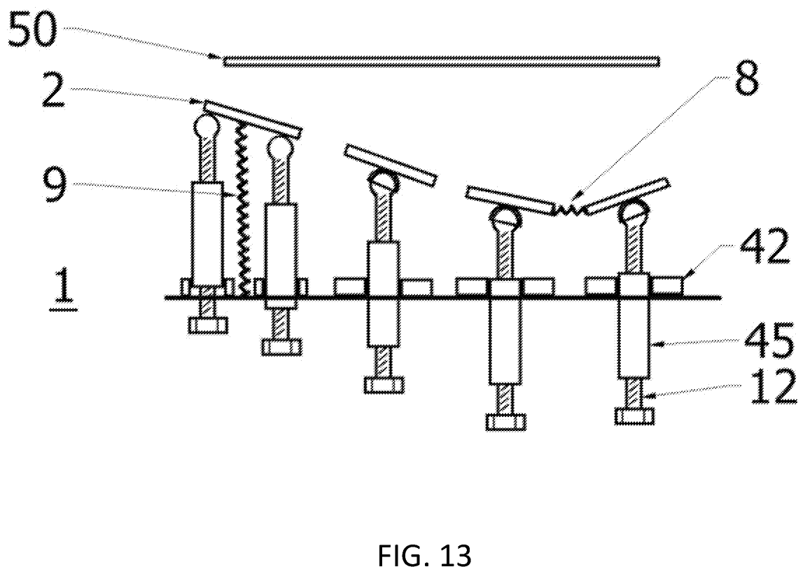

FIG. 13 depicts the latter course of action. In FIG. 13, the system 1 is in its finely-tuned state and is ready to be used as a mold to mold a work piece 50.

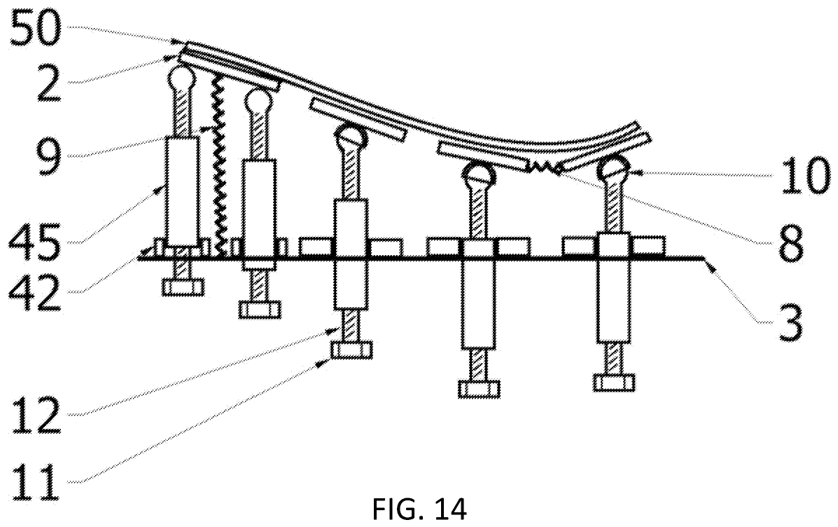

FIG. 14 depicts the system 1 after it has been used to mold the work piece 50 to conform it to the adjustable surface 2. It should be noted that another molding surface (not shown) may be used to press the work piece 50 against the adjustable surface 2 to cause the work piece to take the shape of the adjustable surface 2. The system 1 in its finely-tuned state can be used to mold a plurality of the work pieces into the same shape, such as for mass production.

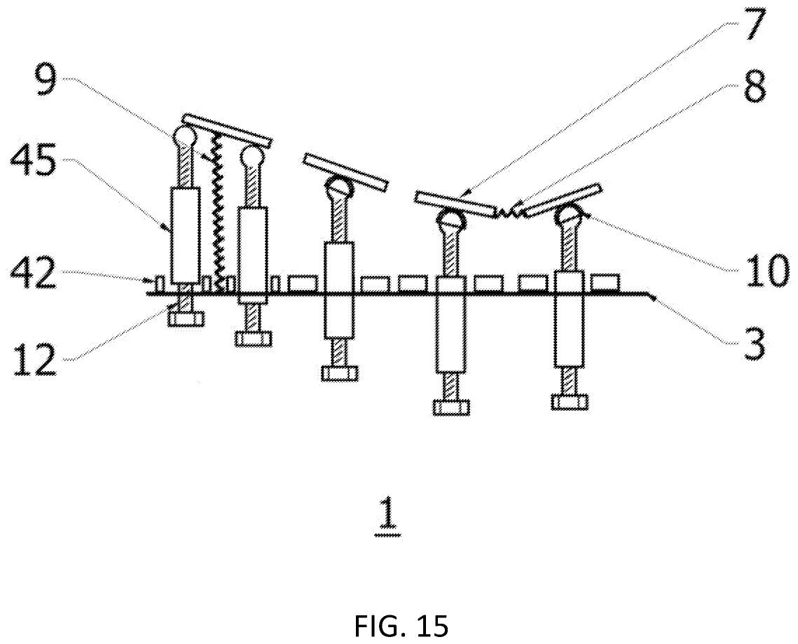

FIG. 15 shows the system 1 in its unlocked state such that the actuators 4 comprising screws 12 and sleeves 45 are allowed to move freely in their axial directions to allow them to be repositioned to perform another molding task.

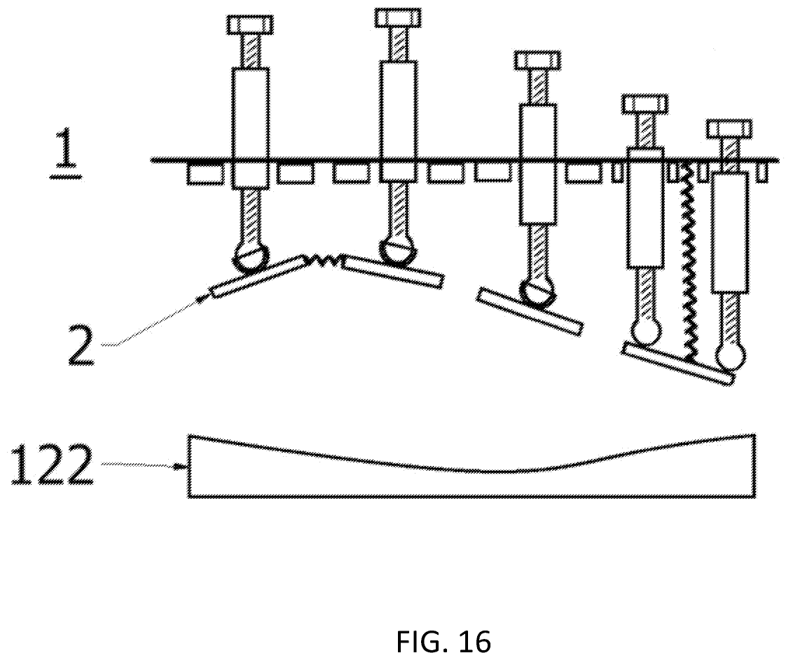

In FIG. 16, the system 1, in its unlocked state, is about to be coarsely tuned by causing the adjustable surface 2 and a new negative surface 122 to be placed in contact with one another such that the adjustable surface 2 conforms to the surface 122, after which the clamps 42 will be placed in the clamped positions to lock in the positions of the tiles 7. The fine-tuning steps and the other steps in the process described above with reference to FIGS. 10-16 may then be performed.

### Methods

In summary, features of the methods disclosed herein include, but are not limited to, using the quick release mechanism to allow the actuators to move freely in their axial directions, placing an object such as a flexible metal surface, a cheaply machined foam or a 3-D printed negative into substantial contact with the adjustable surface and allowing the tiles of the adjustable surface to conform to the surface shape of the object. The locking mechanism is then locked to lock in the positions (coarse tuning) of the actuators. The fine tuning process described above is then performed.

The mold can be placed on a computer-adjusted negative which can operate at moderate temperatures. Once the quick-release adjustable surface is shaped against it, it can be placed in a high temperature environment.

Robotic arms or arrays of motorized adjusters can adjust the actuators to the desired geometry during the fine tuning process.

The system may be instrumented with a conveyor or other automated material feeds for series production.

Reflective mirrors can be attached to the adjustable surface in order to use deflectometry to set the shape.

Technicians can adjust the rods in order to achieve the desired geometry.

Terrain mockups are made for different reasons in architecture and civil engineering. These mockups represent the configuration of a particular terrain, representing ground contour lines, hills, valleys, canyons and other characteristics for construction or military purposes. These mockups are made in a variety of ways, like machining, 3-D printing, layering construction and others. These mockups can be made and dynamically modified using the inventive principles and concepts disclosed herein.

It should be noted that the inventive principles and concepts have been described with reference to representative embodiments, but that the inventive principles and concepts are not limited to the representative embodiments described herein. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the appended claims.

1. A system comprising:
an adjustable surface comprising a plurality of segments;
a substantially rigid frame;
a plurality of linear actuators, each linear actuator having at least first and second ends, the first ends being coupled to a segment of the adjustable surface and the second ends being coupled to the frame, wherein each linear actuator is adjustable along an axial direction of the respective linear actuator to control a distance between a location on the rigid frame to which the second end of the respective linear actuator is coupled and the segment of the adjustable surface to which the first end of the respective linear actuator is coupled such that adjustment of one or more of the linear actuators adjusts a shape of the adjustable surface.

2. The system of claim 1, wherein said plurality of segments comprise an array of tiles, wherein adjacent tiles of the array of tiles are interconnected by spring elements allowing select degrees of freedom of motion and directions of flexibility while limiting flexibility in other degrees of freedom of motion relative to adjacent tiles.

3-8. (canceled)

9. The system of claim 2, wherein an angle of a tile is controlled at least in part by the spring elements interconnecting the respective tile to one or more adjacent tiles.

10. The system of claim 9, wherein at least one of the tiles is not coupled to any of the actuators.

11. (canceled)

12. The system of claim 2, wherein the spring elements comprise flexure elements, and wherein the tiles and the flexure elements are cut from at least one sheet of material.

13. The system of claim 12, wherein the adjustable surface is cut from a curved sheet of material and the flexure elements are formed in the curved sheet of material.

14. The system of claim 2, wherein at least one of a size and a shape of at least two of the tiles differ and the flexibility and configuration of at least two of the spring elements differ to provide more or less flexibility in the adjustable surface in select directions in select locations of the surface.

15-24. (canceled)

25. The system of claim 1, wherein a shape of the adjustable surface is achieved by placing the adjustable surface in contact with a negative surface having a preselected shape that causes the adjustable shape to conform to the other surface.

26. The system of claim 25, wherein the couplings between the first ends of the actuators and the adjustable surface allow the shape of the adjustable surface to be changed to a new shape without altering the linear positions of the actuators by allowing a loss of tension or pressure in the couplings between the first ends of the actuators and the adjustable surface.

27-30. (canceled)

31. A system comprising:
a substantially rigid frame;
a plurality of linear actuators, each actuator being adjustable along an axial direction of the actuator;
an adjustable surface mechanically coupled to the plurality of actuators, wherein adjustment of the actuators adjusts a shape of the adjustable surface, and vice versa;
a locking mechanism, the locking mechanism being configured to lock the actuators in preselected axial positions, wherein locking in the actuators at the preselected axial positions causes the adjustable surface to have a preselected shape; and
a quick-release mechanism, actuation of the quick-release mechanism causing the locking mechanism to unlock, wherein unlocking of the locking mechanism frees the actuators to allow the actuators to move freely in the axial directions of the actuators.

32. The system of claim 31, wherein each actuator can be fine tuned after the actuators have been locked in the preselected axial positions.

33. The system of claim 32, wherein each actuator can be coarsely tuned by actuating the quick-release mechanism to cause the locking mechanism to unlock and causing an external surface having a preselected shape to be placed in contact with the adjustable surface, wherein causing the external surface to be placed in contact with the adjustable surface causes the adjustable surface to exert forces on the actuators that cause the actuators to be coarsely tuned to the preselected axial positions of the actuators, wherein once the actuators have been coarsely tuned, the locking mechanism can be locked to lock the actuators in the coarsely tuned preselected axial positions.

34-41. (canceled)

42. The system of claim 31, wherein the substantially rigid frame comprises:
pairs of bars each of which comes together to clamp on at least one actuator to lock the shape of the corresponding portion or portions of the adjustable surface, and wherein each pair of bars can also separate to release the actuator or actuators to unlock the shape of the corresponding portion or portions of the adjustable surface; or
a stack of two or more bars and one or more actuators is situated between bars in the stack such that screws that run the length of the stack provide the locking mechanism by compressing the stack of bars to thereby clamp down on the actuator or actuators in order to lock the shape of the adjustable surface.

43. (canceled)

44. The system of claim 31, wherein the locking system clamps onto a sleeve made with an internal hole that engages the actuator, and wherein as the locking system unlocks, the sleeve and actuator are allowed to slide freely along the axis of motion of the actuator to allow the locking mechanism to be clamped down on a new location of the sleeve.

45. The system of claim 31, wherein when the locking system is unlocked and the adjustable surface is mated with a shaped surface, the actuators slide in the axial directions of the actuators to cause the adjustable surface to conform to the shape of the shaped surface, and wherein once the adjustable surface has conformed to the shape of the shaped surface, the locking mechanism is locked to lock in the positions of the actuators to provide for rapid shaping of the adjustable surface.

46. The system of claim 33, wherein the adjustable surface, after it has been coarsely tuned and finely tuned, comprises a mold for forming curved sheets of metal, plastic, glass, or other material in a convection and radiation oven.

47-49. (canceled)

50. A method for shaping a surface to have a preselected shape, the method comprising:
actuating a quick-release mechanism to cause a locking mechanism to unlock, wherein unlocking of the locking mechanism frees a plurality of linear actuators to allow the linear actuators to move freely in axial directions of the linear actuators.
placing an adjustable surface in contact with the surface having the preselected shape, the adjustable surface comprising a flexible surface that is mechanically coupled to the plurality of linear actuators, each actuator being adjustable along an axial direction of the actuator and being coupled to a substantially rigid frame, wherein placing the adjustable surface in contact with the surface having the preselected shape causes some or all of the actuators to adjust the linear positions of the actuators; and
with the locking mechanism, locking the actuators in the linear positions, wherein locking the actuators in the linear positions causes the adjustable surface to substantially conform to the preselected shape.

51. The method of claim 50, further comprising:
after locking the actuators in the linear positions, performing a fine tuning process that measures the shape of the adjustable surface and fine tunes the linear positions of the actuators to ensure that the adjustable surface precisely conforms to the preselected shape.

52. The method of claim 51, further comprising:
after using fine tuning the adjustable surface, using the adjustable surface as a mold to mold a part having the preselected shape.

53. The method of claim 52, further comprising:
after using the adjustable surface as a mold to mold a part having the preselected shape, performing a fine tuning process that measures the shape of the molded part and fine tunes the linear positions of the actuators to ensure that the adjustable surface produces a part accurately and precisely having the preselected shape.
